(19) United States
(12) Patent Application Publication
(10) Pub. No.: US 2025/0073833 A1
(43) Pub. Date: Mar. 6, 2025

(54) JIG FOR INSTALLATION OF GRAPHICS PROCESSING UNIT BASE BOARD

(71) Applicant: ZT GROUP INT'L, INC. DBA ZT SYSTEMS, SECAUCUS, NJ (US)

(72) Inventors: David Liang, West Orange, NJ (US); Jay Pathak, Monroe Township, NJ (US); Armani Villafane, North Bergen, NJ (US)

(73) Assignee: ZT GROUP INT'L, INC. DBA ZT SYSTEMS, SECAUCUS, NJ (US)

(21) Appl. No.: 18/462,052

(22) Filed: Sep. 6, 2023

(51) Int. Cl. B23P 19/10

(52) U.S. Cl. CPC B23P 19/10

(57) ABSTRACT

A jig includes a lifting component and a sliding component. The lifting component is operable to receive a graphics processing unit (GPU) tray. The lifting component includes one or more grooves operable to receive the GPU tray. A sliding component is operable to receive a GPU board when the sliding component is in a reception configuration. The sliding component is operable to transition from the reception configuration to a deployment configuration where the GPU board is received in the GPU tray.

### FIELD

The present disclosure relates generally to a jig operable to install a graphics processing unit (GPU) board onto a GPU tray.

### BACKGROUND

A conventional graphics processing unit (GPU) board includes eight GPU modules and other functional hardware with a total weight of about 55 pounds. There are 17 threaded standoffs used to fasten the GPU base board to a chassis or a sub-system enclosure, such as a GPU tray.

### BRIEF DESCRIPTION OF THE DRAWINGS

Implementations of the present technology will now be described, by way of example only, with reference to the attached figures, wherein:

FIG. 1 illustrates a GPU system;

FIG. 2A illustrates a GPU assembly including a GPU tray that receives a GPU board;

FIG. 2B illustrates the GPU board;

FIG. 3A illustrates a conventional installation of a GPU board onto a GPU tray;

FIG. 3B illustrates the GPU tray;

FIG. 4 illustrates a jig including a sliding component and a lifting component;

FIG. 5A illustrates the sliding component of the jig in a reception configuration;

FIG. 5B illustrates the sliding component in a deployment configuration;

FIG. 5C illustrates a plurality of friction reducing devices included in the sliding component;

FIG. 6A illustrates a lifting component of the jig in a first configuration;

FIG. 6B illustrates the lifting component in a second configuration;

FIG. 7A illustrates the jig;

FIG. 7B illustrates the lifting component transitioning to the second configuration;

FIG. 7C illustrates the GPU tray being received by the lifting component and the sliding component;

FIG. 7D illustrates the lifting component transitioning to the first configuration, and the GPU base board being received by the sliding component;

FIG. 7E illustrates the sliding component transitioning to the deployment configuration so that the GPU board is received by the GPU tray;

FIG. 7F illustrates the lifting component transitioning to the second configuration, and the sliding component transitioning to the reception configuration; and

FIG. 7G illustrates the removal of the jig.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” means reasonably close to the particular value. For example, about does not require the exact measurement specified and can be reasonably close. As used herein, the word “about” can include the exact number. The term “near” as used herein is within a short distance from the particular mentioned object. The term “near” can include abutting as well as relatively small distance beyond abutting. The terms “comprising,” “including” and “having” are used interchangeably in this disclosure. The terms “comprising,” “including” and “having” mean to include, but not necessarily be limited to the things so described.

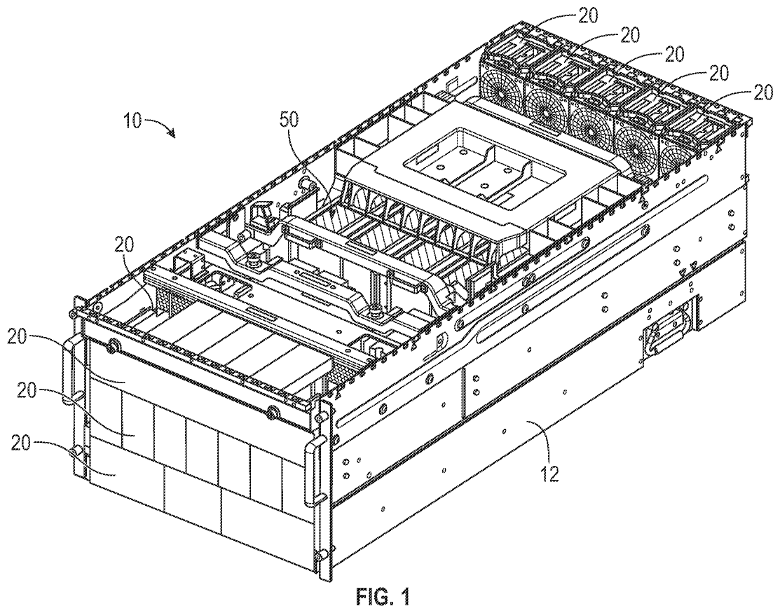

FIG. 1 illustrates a graphics processing unit (GPU) system 10. The GPU system 10 includes a chassis 12 that is operable to receive a GPU assembly 50 and a plurality of other computing components 20, for example fans, chips, hard drives, motherboards, processors, etc.

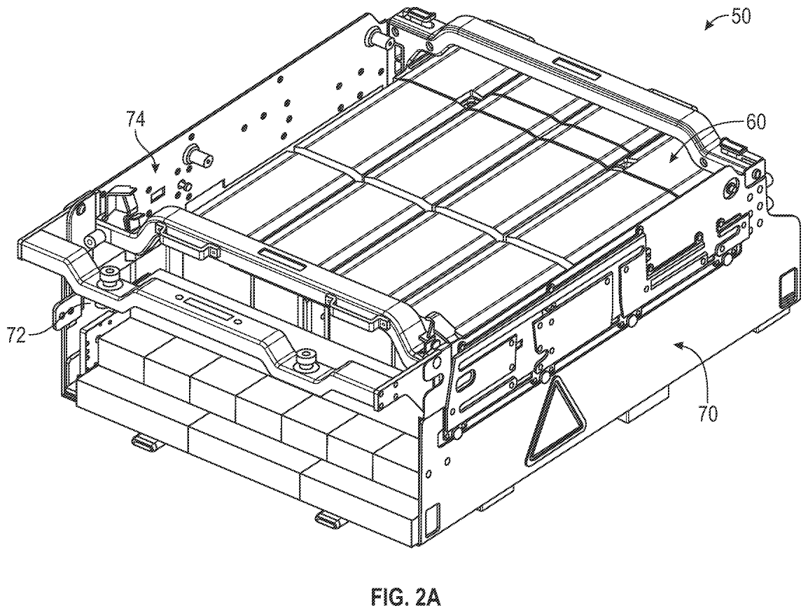

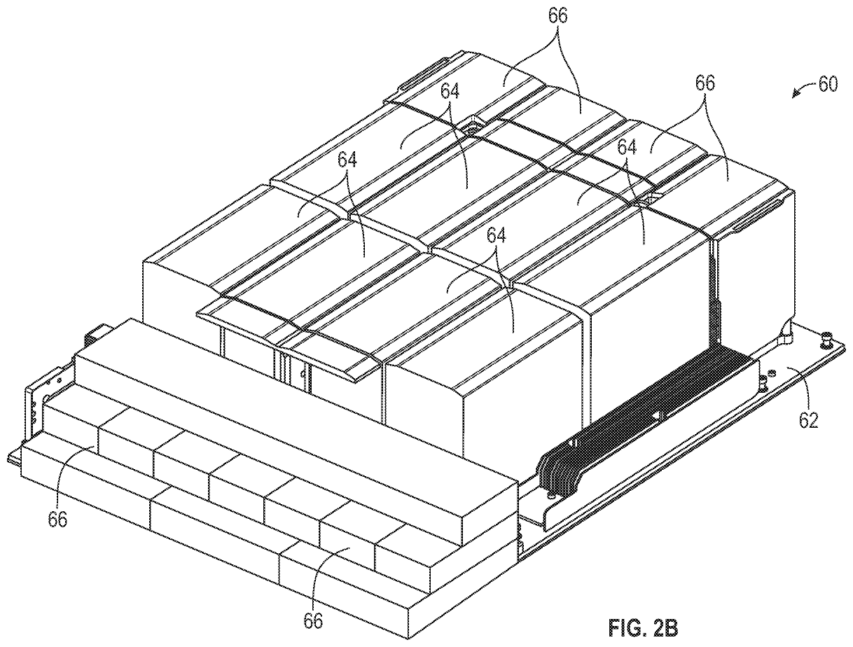

FIG. 2A illustrates the GPU assembly 50. The GPU assembly 50 includes a GPU board 60 and a GPU tray 70. The GPU tray 70 includes side walls 72 that form a receiving area 74. The receiving area 74 is operable to receive the GPU board 60. The GPU board 60 is then installed into the GPU tray 70.

FIG. 2B illustrates the GPU board 60. The GPU board 60 includes a base board 62. The base board 62 can be operable to receive and/or be coupled to at least one GPU module 64. As illustrated in FIG. 2B, the GPU board 60 includes eight GPU modules 64. In other examples, the GPU board 60 can include up to or more than eight GPU modules 64. The GPU board 60 can also include a plurality of functional hardware 66, for example memory, heat sinks, fans, etc. With the base board 62, the GPU modules 64, and the functional hardware 66, the GPU board 60 can have a large weight, for example about 55 pounds. Because the GPU board 60 can weigh about 55 pounds, it can be difficult to maneuver the GPU board 60 in a controlled manner for installation into the GPU tray 70.

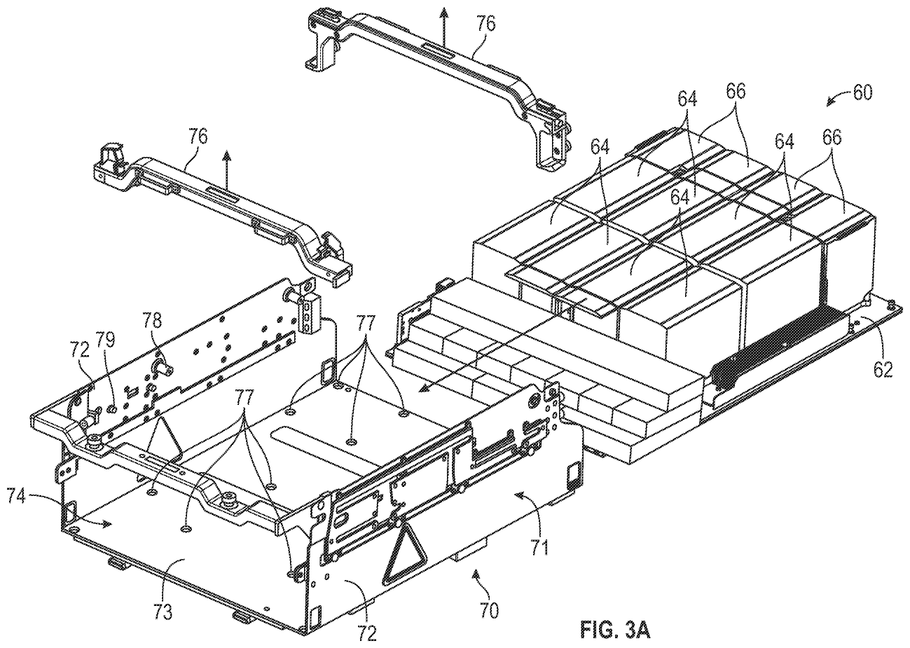

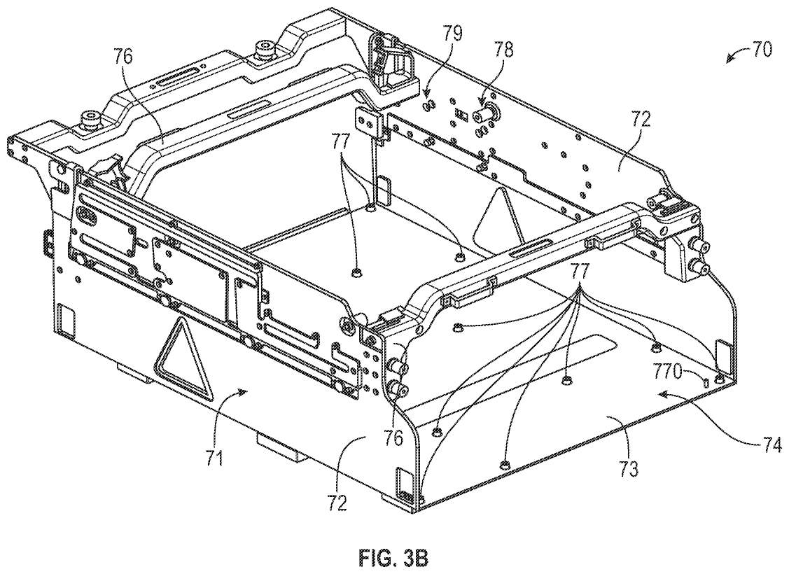

As shown in FIG. 3A, the GPU board 60 needs to be installed into the GPU tray 70 by being translated along a longitudinal axis. During installation, handles 76 of the GPU tray 70 are separated from the housing 71 of the GPU tray 70.

Referring to FIGS. 3A and 3B, the GPU tray 70 includes the housing 71 which can include a bottom 73 and two sides 72 extending from opposing sides of the bottom 73. The two sides 72 and the bottom 73 can form the receiving area 74 operable to receive the GPU board 60. The handles 76 can be removably coupled with each of the two sides 72 such that the handles 76 extend between the two sides 72. In at least one example, as illustrated in FIGS. 3A and 3B, the GPU tray 70 can include two handles 76. In some examples, the GPU tray 70 can include one, three, or more handles 76. The handles 76 can be operable to allow a user to grip the handles 76 to lift and/or move the GPU tray 70 and/or the GPU assembly 50 when the GPU board 60 is installed in the GPU tray 70.

The GPU tray 70 includes mechanical features installed on the sides 72 and/or the bottom 73, such as one or more alignment pins 770, standoffs 77, thumbscrews 78, and/or T-pins 79. As illustrated in FIGS. 3A and 3B, the thumbscrews 78 and/or T-pins 79 can be installed on at least one side 72 of the GPU tray 70. The standoffs 77 and/or the alignment pins 770 can be installed on the bottom 73. The one or more alignment pins 770 can be utilized to align the GPU board 60 with the GPU tray 70 before resting the GPU board 60 onto the GPU tray 70. The standoffs 77 can be utilized to fasten the GPU board 60 to the housing 71 of the GPU tray 70, for example once the GPU board 60 is aligned with the GPU tray 70 via the alignment pins 770. In at least one example, the GPU tray 70 can include seventeen standoffs 77. It can be contemplated that more or less standoffs 77 can be utilized without deviating from the scope of the disclosure. In at least one example, the screws 77 can include threaded standoffs, but other types of fasteners can be utilized without deviating from the scope of the disclosure.

The GPU board 60 cannot be installed into the GPU tray 70 from the top of the GPU tray 70, as mechanical features such as the T-pins 79 and the thumbscrews 78 obstruct the path from above and would be damaged. Accordingly, for installation into the GPU tray 70, the GPU board 60 must be translated at a specific height such that the GPU board 60 is not damaged. Also, the GPU board 60 must be translated and maintained at within a specific range of elevation during installation to avoid the standoffs 77 on the GPU tray 70 damaging the components on the bottom side of the GPU board 60. Additionally, the GPU board 60 must be installed carefully to not damage or break components of the GPU tray 70, for example the thumbscrews 78 or the T-pins 79. Given the requirements and fine movements required for installation of the GPU board 60 into the GPU tray 70, the additional factor of the weight of the GPU board 60 being about 55 pounds makes it difficult to maneuver the GPU board 60 during installation into the GPU tray 70.

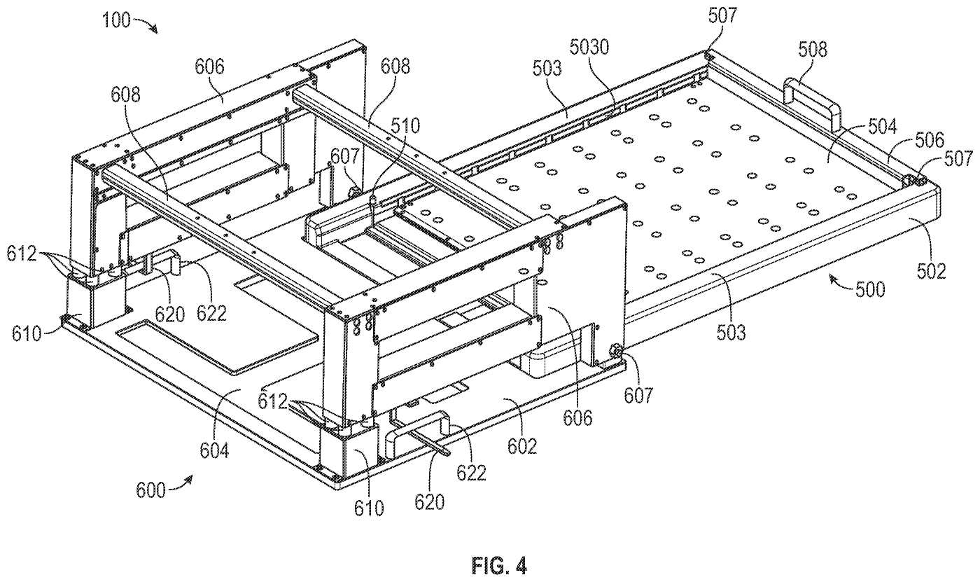

To assist with installation of the GPU board 60 into the GPU tray 70, a jig 100 as disclosed herein can be utilized. FIG. 4 illustrates the jig 100. The jig 100 can shorten the installation time and reduce the fallout rate. The jig 100 is operable to convey the GPU board 60 into the GPU tray 70 for installation.

The jig 100 includes a sliding component 500 and a lifting component 600.

The sliding component 500 is operable to receive the GPU board 60, and the lifting component 600 is operable to receive the GPU tray 70. The sliding component 500 is operable to translate the GPU board 60 into the GPU tray 70. With the sliding component 500, the user(s) does not have to try to lift the GPU board 60 and maintain the height of the GPU board 60 while inserting into the GPU tray 70 to avoid damaging the mechanical features such as the standoffs 77, the thumbscrews 78, and/or the T-pins 79.

The lifting component 600 is operable to assist with ensuring that the GPU board 60 and the GPU tray 70 are aligned so that the GPU board 60 can be easily inserted into the GPU tray 70 in the correct position for installation. After the GPU board 60 is received in the GPU tray 70, the GPU board 60 needs to be lifted to remove the sliding component 500 from underneath the GPU board 60. In at least one example, the lifting component 600 can provide one or more handles 608 which the user can hold onto and/or push against while lifting the GPU board 60 to prevent injury and make the lift easier for the user. In at least one example, the handles 608 can provide leverage for the user to align the GPU board 60 with the standoffs 77 more accurately. Too much misalignment can cause damage to the underside of the GPU board 60 by the standoffs 77.

With the jig 100, the damage rate of the expensive GPU board 60 is reduced by avoiding unwanted collision between the GPU board 60 and the surrounding structure of the GPU tray 70. The jig 100 improves ergonomics by eliminating the step that requires human strength to lift the heavy GPU board 60 to travel for a long distance while inserting into the GPU tray 70. Also, the jig 100 can improve accuracy of blind mating the GPU board 60 with the standoffs 77 of the GPU tray 70. The jig 100 is intuitive to use, is easy to manufacture, and is effective in installing the GPU board 60 into the GPU tray 70. In at least one example, the jig 100 can be retrofit to the GPU board 60 and the GPU tray 70 so that there is no need for modifications of the GPU board 60 and/or the GPU tray 70 to utilize the jig 100 for installation.

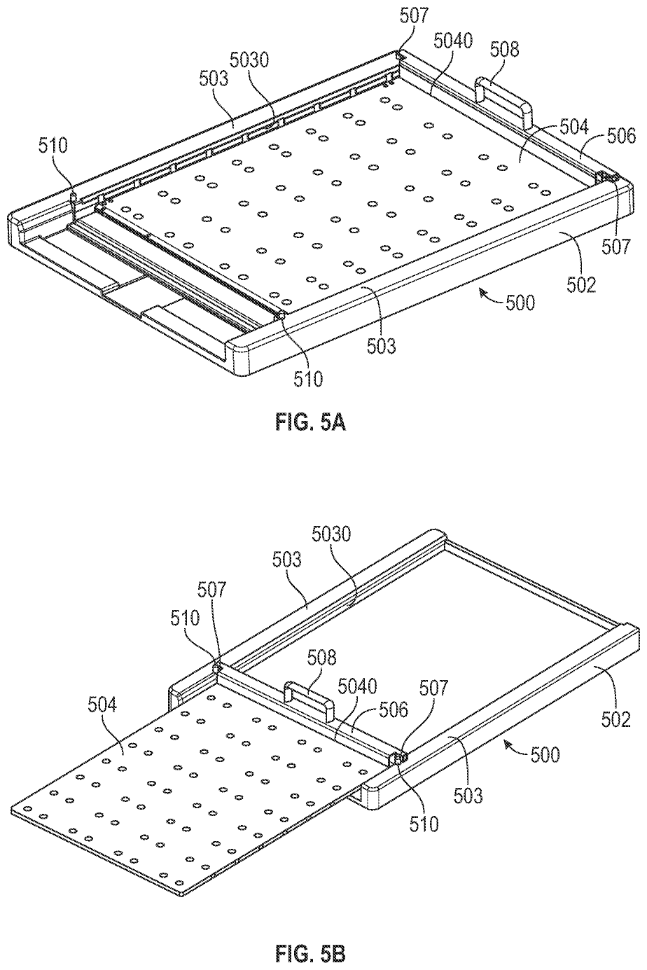

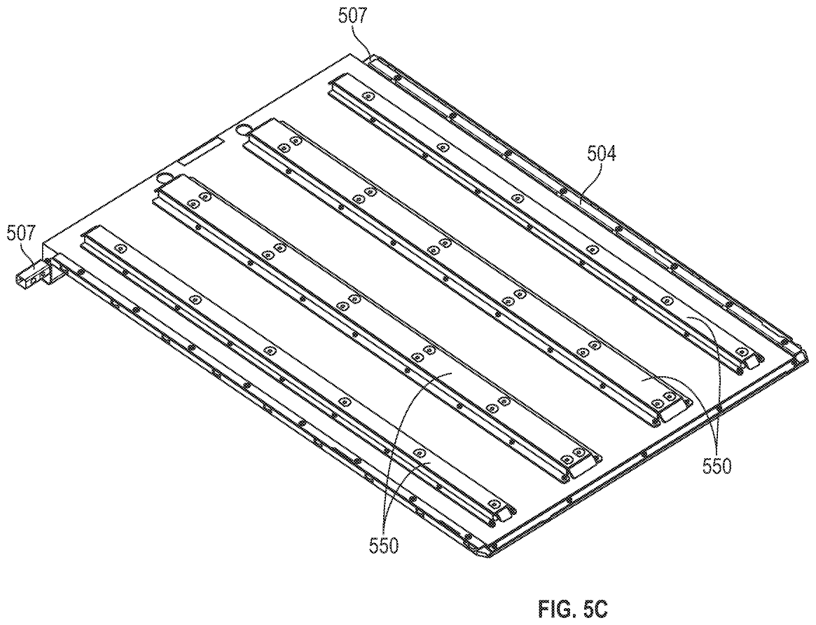

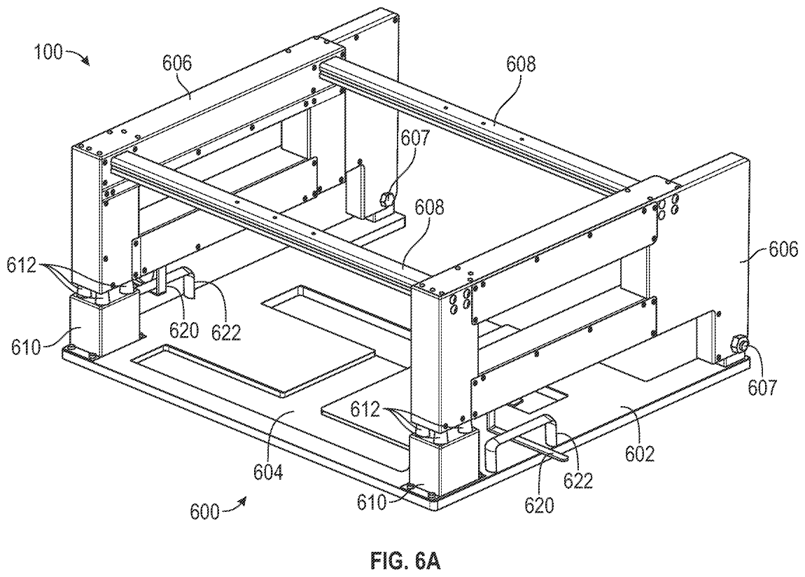

FIG. 5A illustrates the sliding component 500 in a reception configuration, and FIG. 5B illustrates the sliding component 500 in a deployment configuration. The sliding component 500 is operable to receive the GPU board 60 when the sliding component 500 is in the reception configuration. The sliding component 500 is operable to transition from the reception configuration to the deployment configuration where the GPU board 60 is received in the GPU tray 70.

The sliding component 500 includes a base 502 and a dolly 504. The base 502 is operable to receive the dolly 504 and guide the dolly 504 so that the GPU board 60 enters the GPU tray 70 in the desired position. When the sliding component 500 transitions from the reception configuration to the deployment configuration, the dolly 504 can be translated and/or slid along a longitudinal axis of the base 502.

The base 502 can include two rails 503 that are operable to receive and guide the dolly 504 so that the dolly 504 translates along the rails 503 in the desired direction. The rails 503 can include grooves for roller tracks. One or more of the rails 503 may include chamfered edges 5030 to assist with guiding the GPU board 60 during placement of the GPU board 60 on the sliding component 500 (e.g., the dolly 504) in the reception configuration. The base 502 can create the same elevation as the GPU tray 60, for example on a work bench. Additionally, the dolly 504 fits in the space between the GPU tray 70 and the GPU board 60. Accordingly, the GPU board 60 can be easily inserted into the GPU tray 70 without excess handling of the weight of the GPU board 60.

The dolly 504 is operable to support the weight of the GPU board 60 to avoid fluctuation of the elevation during transporting the GPU board 60 into the GPU tray 70. In at least one example, the dolly 504 can include guiding features to avoid any components of the GPU board 60 from colliding with any surrounding structure of the GPU tray 70 that may cause damage.

In at least one example, the dolly 504 can include a foam pad 5040 to protect the GPU board 60 when aligning. In at least one example, the dolly 504 can include a polyester sheet such as mylar for placement of the GPU board 60. In some examples, the dolly can 504 can include a polycarbonate sheet and/or a Formex sheet for placement of the GPU board 60.

When transitioning from the reception configuration (FIG. 5A) to the deployment configuration (FIG. 5B), the dolly 504 translates or slides in and out of the base 502. In at least one example, the dolly 504 can include a push end 506 where the user can exert force to slide the dolly 504 in relation to the base 502. The push end 506 can include one or more handles 508 to provide the user grip or hand placement.

In at least one example, to help with alignment of the dolly 504 as well as to maintain the dolly 504 within the base 502, the base 502 can include one or more dowels 510 that extend from the base 502. The dowels 510 can be positioned on the base 502 opposite the push end 506 of the dolly 504. In some examples, the dowels 510 can extend from the rails 503. The dolly 504 can include one or more stops 507 that correspond with the dowels 510 such that the stops 507 (as shown in FIG. 5B) abut against the corresponding dowels 510 to prevent the dolly 504 from continued translation when in the deployment configuration. In at least one example, the stops 507 can be formed from the push end 506. In some examples, the stops 507 can extend from the push end 506.

In at least one example, as illustrated in FIG. 5C, the dolly 504 can include a plurality of friction reducing devices 550 to translate the dolly 504 along the horizontal plane. In at least one example, the friction reducing devices 550 can be in the form of roller tracks and/or any similar friction reduction and load bearing device which includes but is not limited to wheels, ball bearings, Teflon sheets, etc. The friction reducing devices 550 can provide frictionless translation of the dolly 504 for an effortless movement of the heavy GPU board 60. The friction reducing devices 550 can be positioned along the bottom of the dolly 504 opposite relative to the foam pad 504. Accordingly, the friction reducing devices 550 can roll and/or slide against the base 502 of the sliding component 500. In some examples, the friction reducing devices 550 can be positioned such that the friction reducing devices 550 slide and/or roll against the rails 503 of the base 502.

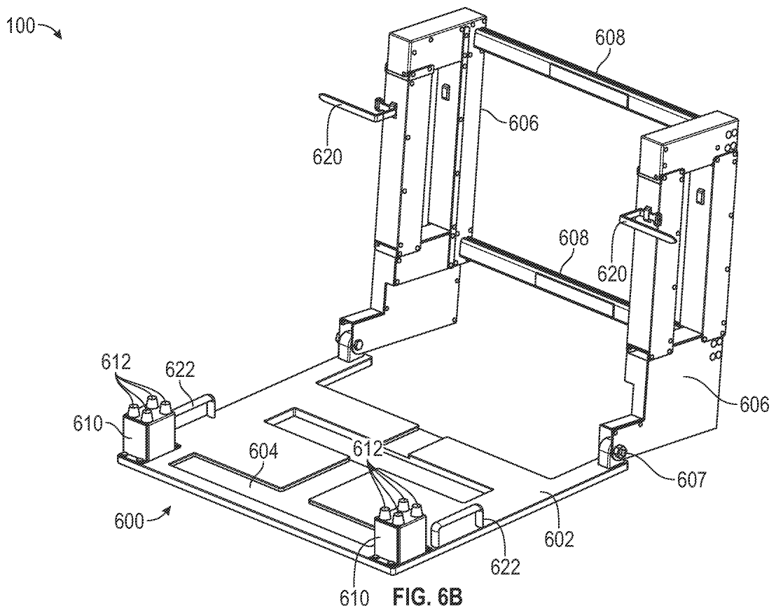

FIG. 6A illustrates the lifting component 600 in a first configuration, ad FIG. 6B illustrates the lifting component in a second configuration.

The lifting component 600 can facilitate the purpose of temporary support handles, for example for when the GPU board 60 needs to be momentarily lifted to remove the dolly 504 and settled down onto the standoffs 77 and/or the alignment pins 770 of the GPU tray 70. The lifting component 600 can be light weight and yet strong to support the weight of the GPU tray 70 and the GPU board 60.

The lifting component 600 can include a base 602 operable to receive the GPU tray 70. In some examples, the base 602 of the lifting component 600 can include one or more grooves 604 that are operable to receive the GPU tray 70 and assist with alignment of the GPU tray 70. In some examples, the grooves 604 can correspond with a bottom 73 of the GPU tray 70. The grooves 604 can prevent movement of the GPU tray 70 during installation of the GPU board 60. Also, the grooves 604 can assist with aligning the GPU tray 70 so that the GPU tray 70 is in the desired position for receiving the GPU board 60 via the sliding component 500.

In at least one example, the base 602 can be operable to receive the sliding component 500. In at least one example, the sliding component 500 can be coupled with the lifting component 600 to ensure that the GPU board 60 is correctly aligned to be inserted into the GPU tray 70. In some examples, the sliding component 500 can be removably coupled with the lifting component 600.

The lifting component 600 can include two frames 606 on opposing sides of the base 602. At least one handle 608 can span the two frames 606. As illustrated in FIGS. 6A and 6B, the lifting component 600 can include two handles 608. One, three, or more handles 608 can be included without deviating from the scope of the disclosure. The handles 608 can be utilized by the user to facilitate a secure and safe assembly process of the GPU board 60 and the GPU tray 70 by preventing human injuries as well as any damage to the GPU board 60. The handles 608 can serve as temporary handles so that the user can rest their hand and/or palm and use their forearm muscles to lift the GPU board 60 so that the dolly 504 can be removed from underneath the GPU board 60. The user can then use the handles 608 as support as the user slowly lowers the GPU board 60 onto the GPU tray 70 by aligning the one or more alignment pins 770 and/or the standoffs 77. With the lifting component 600 and the sliding component 500 of the jig 100, in some examples, a single user can perform the installation of the GPU board 60 into the GPU tray 70. The at least one handle 608 can be coupled with the two frames 606 and can be operable to withstand a stabilizing counterforce by the user when the user is lifting the GPU board 60.

In at least one example, as illustrated in FIGS. 6A and 6B, the two frames 606 can be hingedly coupled with the base 602. The two frames 606 can each include a hinge 607 where the frames 606 hinge and/or pivot. By providing a hinge 607, the operation can be effortless with less moving parts.

The lifting component 600 can include two stands 610 that correspond with the two frames 606. In at least one example, the two stands 610 can be coupled to and/or extend from the base 602. The two stands 610 can be operable to receive the two frames 606 when transitioned to the first configuration (as shown in FIG. 6A). In at least one example, the two stands 610 can each include one or more bumpers 612 operable to absorb force from the two frames 606 when the two stands 610 receive the two frames 606. In at least one example, the bumpers 612 can be rubber isolator bumpers.

In at least one example, each of the two frames 606 can include a fastener 620 operable to couple with a corresponding coupler 622 included on the base 602. The fastener 620 and the coupler 622 can be operable to couple the two frames 606 with the base 602 to prevent undesired rotation and/or translation of the two frames 606. Accordingly, when the lifting component 600 is in the first configuration, the fasteners 620 can couple with the couplers 622 to prevent undesired movement of the frames 606, for example when the user is lifting the handles 608. In at least one example, the fasteners 620 can include a hook and loop fastener. In some examples, the fasteners 620 can include adhesives, buttons, etc. without deviating from the scope of the disclosure. The couplers 622 can include a ring or a handle so that the fasteners 620 can pass through the couplers 622. The couplers 622 can extend from and/or be coupled to the base 602.

In the second configuration, as illustrated in FIG. 6B, the two frames 606 can pivot about the hinges 607 so that the two frames 606 are lifted off and/or separated from the base 602. In the second configuration, the GPU tray 70 can be deposited onto the base 602.

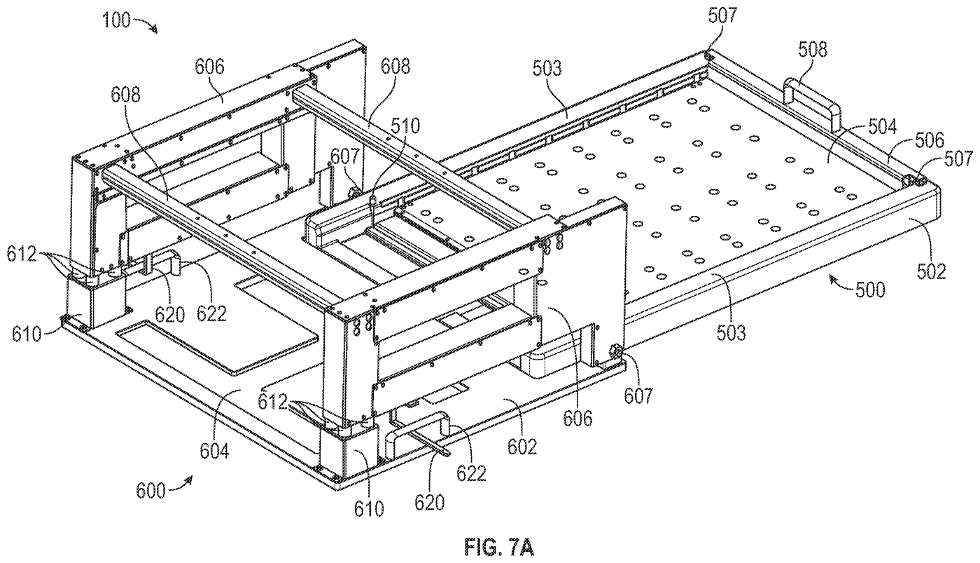

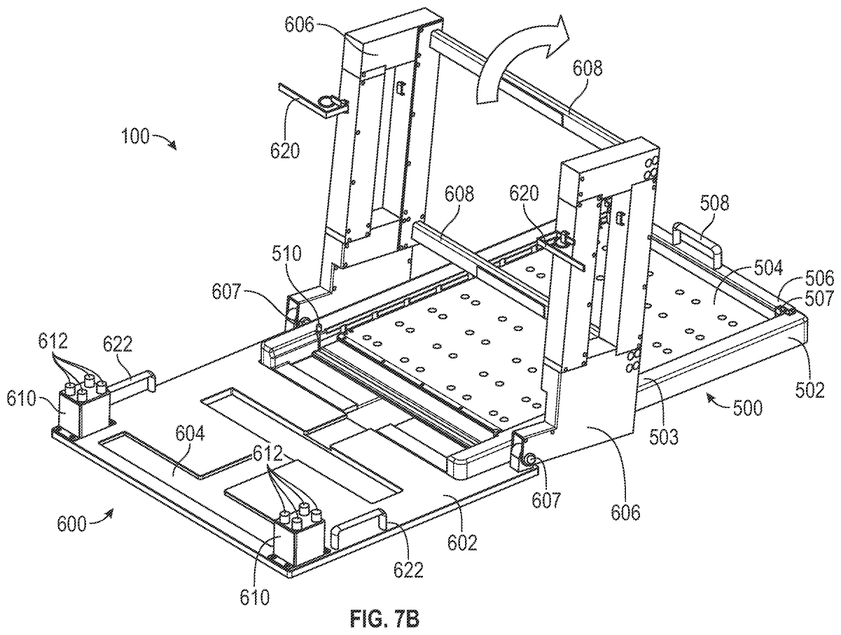

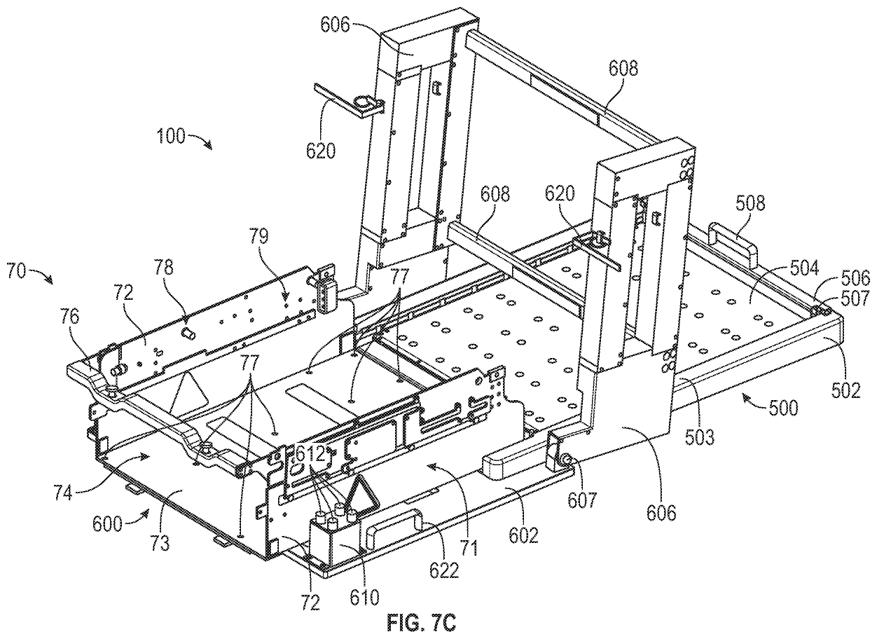

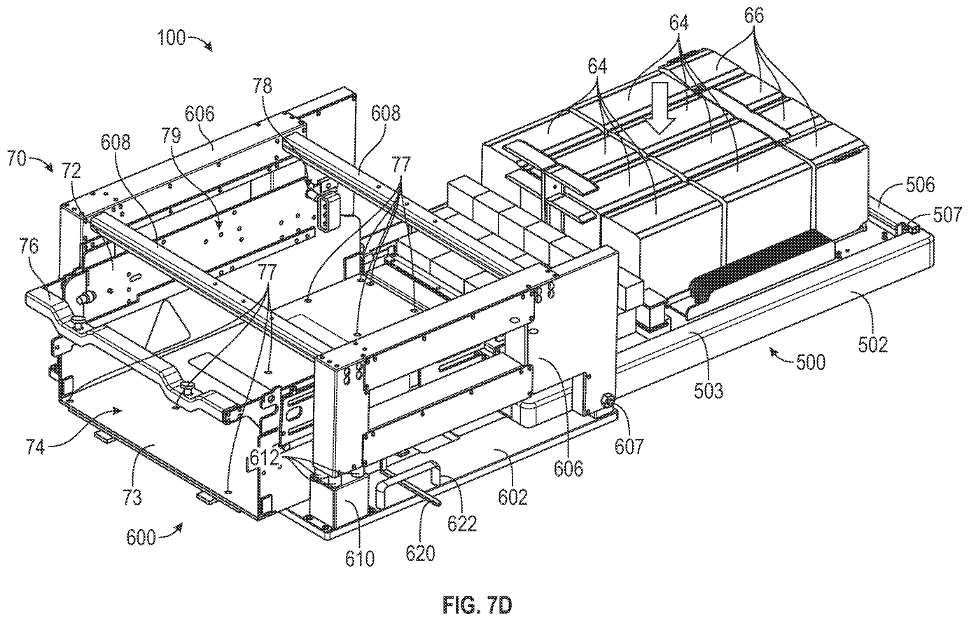

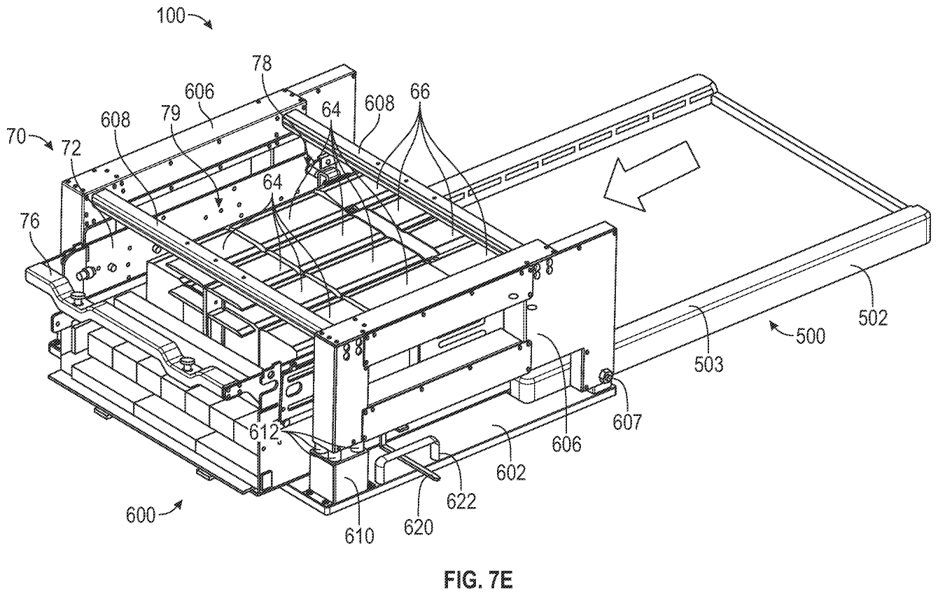

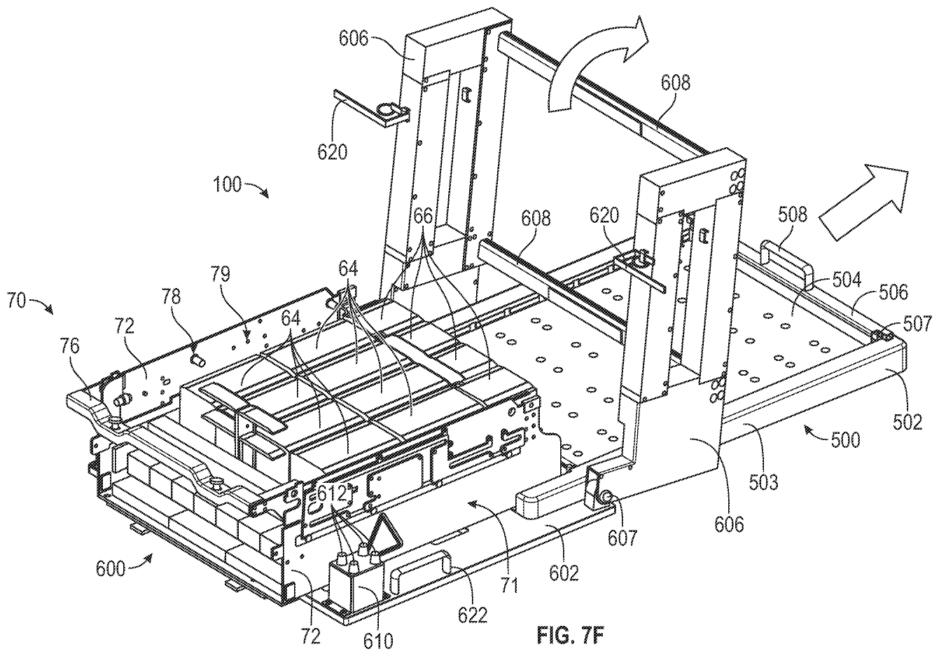

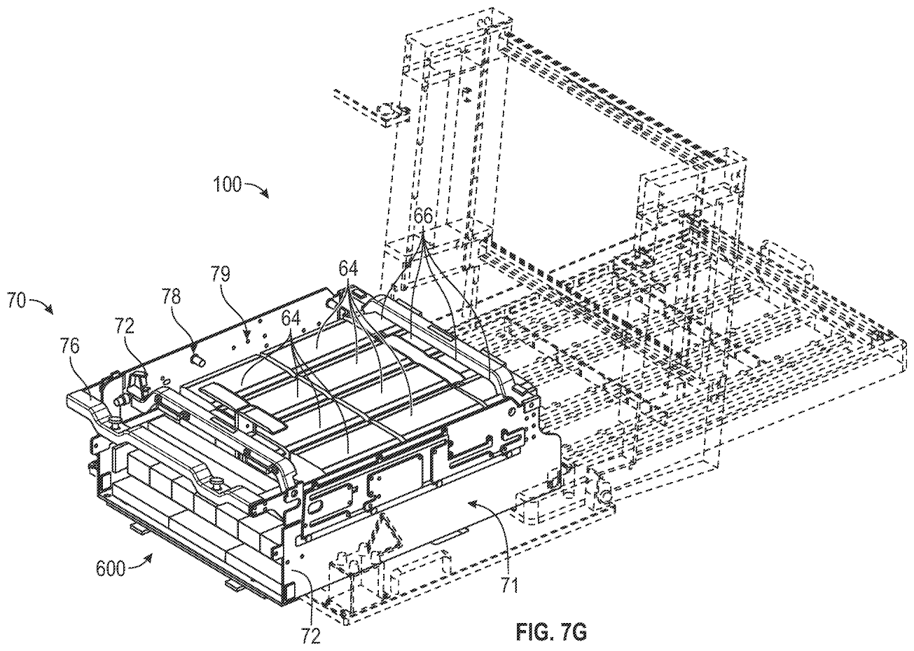

FIGS. 7A-7G illustrate the installation of the GPU board 60 into the GPU tray 70 utilizing the jig 100. FIG. 7A illustrates the jig 100 with the sliding component 500 in the reception configuration, and the lifting component 600 in the first configuration. The sliding component 500 is aligned with the lifting component 600.

As illustrated in FIG. 7B, the lifting component 600 is transitioned to the second configuration by pivoting the two frames 606 about the hinges 607 so that the two frames 606 are separated from the base 602.

As illustrated in FIG. 7C, with the lifting component 600 in the second configuration, the GPU tray 70 is placed onto the base 602 of the lifting component 600. The grooves 604 help align the GPU tray 70 and also prevent movement of the GPU tray 70 during installation of the GPU board 60.

As illustrated in FIG. 7D, the lifting component 600 is transitioned to the first configuration where the two frames 606 are received by the supports 610, and the two frames 606 and the handles 608 are positioned above and/or about the GPU tray 70. The GPU board 60 is placed on the dolly 504 of the sliding component 500 in the reception configuration. In at least one example, the GPU board 60 is aligned on the dolly 504 via the chamfered edges 5030 of the rails 503.

As illustrated in FIG. 7E, the sliding component 500 is transitioned to the deployment configuration as the dolly 504 is translated along the horizontal plane. The GPU board 60 is then received by the GPU tray 70.

The GPU board 60 is then briefly lifted with the helping of the handles 608 of the lifting component 600. At the same time, as illustrated in FIG. 7F, the dolly 504 can be pulled out so that the sliding component 500 is transitioned back to the reception configuration. The GPU board 60 is then slowly and gently brought down onto the GPU tray 70 to align with the standoffs 77 and/or the alignment pin(s) 770 on the bottom 73 of the GPU tray 70. The lifting component 600 is transitioned to the second configuration so that the frames 606 are not hindering access to the GPU assembly 50 (e.g., the GPU board 60 and the GPU tray 70).

As illustrated in FIG. 7G, the GPU board 60 is fastened to the GPU tray 70, for example via the standoffs 77, to form the GPU assembly 50. The jig 100 can then be removed and/or the GPU assembly 50 can be removed from the jig 100 to be installed in the GPU system 10, as illustrated in FIG. 1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A jig comprising:
a lifting component operable to receive a graphics processing unit (GPU) tray, wherein the lifting component includes one or more grooves operable to receive the GPU tray; and
a sliding component operable to receive a GPU board when the sliding component is in a reception configuration, wherein the sliding component is operable to transition from the reception configuration to a deployment configuration where the GPU board is received in the GPU tray.

2. The jig of claim 1, wherein the sliding component transitions from the reception configuration to the deployment configuration by translating a dolly that the GPU board is positioned on along a horizontal plane.

3. The jig of claim 2, wherein the dolly includes a foam pad.

4. The jig of claim 2, wherein the dolly includes a plurality of friction reducing devices to translate the dolly along the horizontal plane.

5. The jig of claim 2, wherein the sliding component includes a base that receives the dolly, wherein the base is operable to guide the dolly so that the GPU board enters the GPU tray.

6. The jig of claim 5, wherein the base includes one or more dowels that extend from the base, wherein the dolly includes one or more stops that correspond with the one or more dowels such that the one or more stops abut against the corresponding one or more dowels to prevent the dolly from continued translation when in the deployment configuration.

7. The jig of claim 1, wherein the sliding component includes at least one chamfered edge operable to assist with guiding the GPU board during placement of the GPU board on the sliding component in the reception configuration.

8. The jig of claim 1, wherein the sliding component is removably coupled with the lifting component.

9. The jig of claim 1, wherein the lifting component includes a base operable to receive the GPU tray, wherein the base includes the one or more grooves.

10. The jig of claim 9, wherein the lifting component includes two frames on opposing sides of the base.

11. The jig of claim 10, wherein at least one handle spans the two frames.

12. The jig of claim 11, wherein the at least one handle is coupled with the two frames and is operable to withstand a stabilizing counterforce by a user when the user is lifting the GPU board.

13. The jig of claim 10, wherein the two frames are hingedly coupled with the base.

14. The jig of claim 10, wherein the lifting component includes two stands corresponding with the two frames, wherein the two stands are operable to receive the two frames.

15. The jig of claim 14, wherein the two stands includes one or more bumpers operable to absorb force from the two frames when the two stands receive the two frames.

16. The jig of claim 10, wherein each of the two frames includes a fastener operable to couple with a corresponding coupler included on the base, wherein the fastener and the coupler are operable to couple the two frames with the base to prevent rotation of the two frames.

17. A system comprising:
a graphics processing unit (GPU) board;
a GPU tray operable to receive the GPU board; and
a jig including:
a lifting component operable to receive the GPU tray, wherein the lifting component includes one or more grooves operable to receive the GPU tray; and
a sliding component operable to receive the GPU board when the sliding component is in a reception configuration, wherein the sliding component is operable to transition from the reception configuration to a deployment configuration where the GPU board is received in the GPU tray.

18. The system of claim 17, wherein the sliding component transitions from the reception configuration to the deployment configuration by translating a dolly that the GPU board is positioned on along a horizontal plane.

19. The system of claim 17, wherein the lifting component includes a base operable to receive the GPU tray, wherein the base includes the one or more grooves.

20. The system of claim 17, wherein the sliding component includes at least one chamfered edge operable to assist with guiding the GPU board during placement of the GPU board on the sliding component in the reception configuration.
